(19) United States
(12) Patent Application Publication
(10) Pub. No.: US 2017/0238484 A1
(43) Pub. Date: Aug. 24, 2017

(54) METHOD AND APPARATUS FOR SMART IRRIGATION CONTROLLER

(71) Applicant: Ainesh Arumugam, Irvine, CA (US)

(72) Inventor: Ainesh Arumugam, Irvine, CA (US)

(21) Appl. No.: 15/435,579

(22) Filed: Feb. 17, 2017

Related U.S. Application Data
(60) Provisional application No. 62/297,952, filed on Feb. 22, 2016.

(51) Int. Cl. A01G 25/16; G05B 15/02; G06T 7/90; G06K 9/00; G06K 9/03

(52) U.S. Cl. CPC A01G 25/16; A01G 25/167; G06K 9/00657; G06K 9/036; G06T 7/90; G05B 15/02; G06T 2207/30188; G06T 2207/10024

(57) ABSTRACT

Water is a precious resource in the world, and hence it is imperative to find solutions for an effective use of water, including an efficient irrigation system. A method and apparatus is disclosed that effectively processes the images of the vegetation, determines the optimum weather conditions and the soil moisture conditions, controls irrigation schedules of vegetation to efficiently conserve water while maintaining vegetation health, and predicts the nutrition stress in plants for optimum application of fertilizer when necessary.

### CROSS-REFERENCE TO RELATED APPLICATIONS

This application claims the benefit of the filing date of U.S. Provisional Application No. 62/297,952 filed Feb. 22, 2016 and entitled “METHOD AND APPARATUS FOR SMART IRRIGATION CONTROLLER,” the entire disclosure of which is hereby expressly incorporated by reference herein.

### BACKGROUND

The present disclosure relates generally to irrigation control systems and particularly to irrigation and fertilizer control.

Droughts are lasting periods when an area's precipitation falls below 40% of the average precipitation and the water supply is not enough to satisfy the demands of the vegetation, human, and animal populations. The drought affecting California and many other western and southwestern states has been described as the most severe drought on record. The drought affects approximately 74.5 million United States residents. The demand of water is large, due to a large population. California, one of the heavily affected states, is the agricultural center of the nation, and has the largest population, approximately 37 million residents. With dwindling water supplies, water must be shared between all the residents in the area, including farmers. California farmers and ranchers consume approximately 80% of the state water usage, and they will be taking the brunt of the taxes, fees, and fines that comes with over water usage. The impact will not just be in the Western states, it will be a national impact, because a majority of the United States gets their food from California, as it is a region that grows an abundance of food. As water prices increase, food prices will also increase, because the cost of water would be passed on to the consumer. Therefore, if the drought were to be sustained, long-lasting damage may occur. Water districts are lowering water baselines, and increasing fines and fees for over water usage. The fiscal, environmental, and agricultural damage of the drought requires an immediate and effective solution to ease and alleviate the impact.

In general, water is a precious resource in the world, as shortages occur in areas not affected by drought. It is imperative to find solutions for an effective use of water, including an efficient irrigation system.

Currently, there are a few smart irrigation controllers out there. The four main types of smart irrigation controllers include evapotranspiration controllers, rain detection based controllers, soil moisture based controllers, and weather based controllers.

Evapotranspiration controllers measure the rate of evaporation of water using an infrared or optical sensor, and will begin irrigation when the controller has determined that water has evaporated. The drawback of evapotranspiration controllers is that they are unable to judge when and how much water the vegetation actually needs. For example, the soil may have too much water, and the vegetation only absorbs the amount of water it needs. The remaining water will evaporate, causing the system to overwater the vegetation. Overwatering the vegetation can cause root damage and may cause the vegetation to be more prone to diseases and fungal infections.

Rain detection sensors are sensors which measure if precipitation has fallen and how much precipitation has fallen and send the data to the irrigation controller. When the controller receives this information, the controller will not irrigate the vegetation. The drawback of this method is if there is heavy rain and the vegetation does not need to be watered for a week, the controller will irrigate the vegetation after the rain stops and may overwater.

Soil moisture based controllers use sensors that measure the moisture of the soil, and the controller will water the soil depending on the water content of the soil. The drawback of this approach is if the soil is dry, but the vegetation has all of the water required, the controller will irrigate the vegetation excessively.

The last main type of smart controllers are weather detection based controllers. These controllers detect weather conditions and based on that determines the irrigation schedules. The drawback of this approach is that it does not know the conditions of the soil moisture and vegetation health condition, and it may not irrigate the vegetation efficiently, and may weaken the plant due to a lack or surplus of water.

Even if the vegetation is properly irrigated, without appropriate nutrition the vegetation may not remain healthy and may result in irrigation that may not be effective. The usage of fertilizers to improve vegetation health contributes to climate change. Fertilizers consist of substances and chemicals like methane, carbon dioxide, ammonia, nitrogen, etc., may contribute to the emission of greenhouse gases in the environment. These gases may lead to global warming and weather changes. Also, excessive fertilizer use may deplete the quality of the soil, lead to eutrophication of water bodies and has been suggested to cause health risks like cancer and chronic diseases in humans.

It is desirable that fertilizer is used in an optimum amount. A lack or surplus of fertilizer may cause deleterious effects to the plant. To achieve this goal, a smart control system is needed that can predict the nutrition stress in plants.

A method and apparatus is disclosed that effectively processes the images of the vegetation, determines the optimum weather conditions and the soil moisture conditions, controls irrigation schedules of vegetation to efficiently conserve water while maintaining vegetation health, and predicts the nutrition stress in plants for optimum application of fertilizer when necessary.

### SUMMARY

Aspects of the disclosure provide for an irrigation control system. The irrigation control system includes one or more cameras configured to capture images of vegetation; and at least one processor. The at least one processor is configured to receive a set of images of the vegetation from the one or more cameras, determine a health status of the vegetation based on the received set of images, determine whether to irrigate the vegetation at a first point in time based on the determined health status of the vegetation, and when it is determined to irrigate the vegetation at the first point in time, send instructions to one or more irrigation dispensing elements to irrigate the vegetation.

In one example, the at least one processor is also configured to receive user input including at least one of a preferred irrigation plan, and the determination of whether to irrigate the vegetation at the first point in time is further evaluated on the received user input. In another example, the at least one processor is configured to determine the health status of the vegetation based on the received images by determining a Dark Green Color Index (DGCI) for each of the received set of images, and determining whether the DGCI satisfies a predetermined baseline criterion for the vegetation. The at least one processor in this example is optionally configured to determine a quality value of a given image of the number of images, compare the determined DGCI to an expected range of DGCI values for the vegetation, and when the quality value of the given image is below a quality level or the determined DGCI is below the expected range of DGCI values, replace the given image with another image captured by the camera. Additionally, when qualities of two consecutive images are determined to be below the quality level, the at least one processor is optionally configured to provide a notification to check the camera.

In yet another example, the at least one processor is also configured to determine when to capture, using the camera, each of the images of the vegetation using a look up table, the look up table including recommended timings for when to capture an image for one or both of a given day of the year and a given weather condition. In this example, the at least one processor is configured to determine when to capture each of the images using the look up table by receiving a current weather condition from a weather monitoring and forecast system, accessing a weather condition threshold stored in the look up table based on a day of the year, comparing the current weather condition to the weather condition threshold, and determining that the current weather condition is appropriate for capturing an image when the current weather condition satisfies the weather condition threshold. The at least one processor is alternatively also configured to determine an irrigation requirement based on the determined health status of the vegetation, the irrigation requirement including an amount of irrigation and a duration of irrigation. In this example, the irrigation requirement is optionally also determined according to at least one of a history of irrigation or a history of vegetation health status for the vegetation.

The at least one processor is additionally or alternatively also configured to receive a weather condition or a weather forecast from a weather monitoring and forecast system, wherein the determination of whether to irrigate the vegetation at the first point in time is further based on the weather condition or weather forecast. In this example, the weather condition or the weather forecast includes at least one of wind speed data or temperature data. The at least one processor is additionally or alternatively configured to receive an updated weather condition or an updated weather forecast at a set interval. In another alternative, the system also includes the weather monitoring and forecast system.

In addition, the at least one processor is optionally also configured to determine whether to fertilize the vegetation at a second point in time based on the received data, and when it is determined to fertilize the vegetation at the second point in time, provide instructions regarding the fertilization of the vegetation to a fertilizer control system based on the received data. In this example, the at least one processor is also configured to receive user input including at least one of a preferred fertilizer plan, and the at least one processors is configured to determine whether to fertilize the vegetation at the second point in time in accordance with the received user input. In another alternative, the at least one processor is configured to determine whether to fertilize the vegetation at the second point in time based on the received data by determining a Dark Green Color Index (DGCI) for each of the set of images, and determining a health status of the vegetation based on the determined DGCI, wherein the determination of whether to fertilize the vegetation at the second point in time is based at least on whether the determined health status of the vegetation satisfies a predetermined health criterion. The system optionally also includes the fertilizer control system, wherein the provided instructions include instructions for operating the fertilizer control system.

In another alternative, the system also includes a soil moisture sensor configured to detect a soil moisture level, wherein the at least one processor is further configured to receive the soil moisture level and determine whether to irrigate the vegetation at the first point in time further based on the receive soil moisture level. In yet another example, the at least one processor is configured to determine the health status of the vegetation further based on a type of the vegetation.

Other aspects of the disclosure provide for a method. The method includes receiving, by at least one processor, a set of images of vegetation from one or more cameras; determining, by the at least one processor, a health status of the vegetation based on the received set of images; determining, by the at least one processor, whether to irrigate the vegetation at a first point in time based on the determined health status of the vegetation; and when it is determined to irrigate the vegetation at the first point in time, sending, by the at least one processor, instructions to one or more irrigation dispensing elements to irrigate the vegetation.

In one example, the health status of the vegetation is determined by determining a Dark Green Color Index (DGCI) for each of the received set of images, and determining whether the DGCI satisfies a predetermined baseline criterion for the vegetation. The method optionally also includes determining, by the at least one processor, a quality value of a given image of the number of images; comparing, by the at least one processor, the determined DGCI to an expected range of DGCI values for the vegetation; and when the quality value of the given image is below a quality level or the determined DGCI is below the expected range of DGCI values, replacing, by the at least one processor, the given image with another image captured by the camera.

The method alternatively also includes determining, by the at least one processor, whether to fertilize the vegetation at a second point in time based on the received data; and when it is determined to fertilize the vegetation at the second point in time, providing, by the at least one processor, instructions regarding the fertilization of the vegetation to a fertilizer control system based on the received data. In this example, the method also includes receiving, by the at least one processor, user input including at least one of a preferred fertilizer plan; and determining, by the at least one processor, whether to fertilize the vegetation at the second point in time in accordance with the received user input. In yet another example, whether to fertilize the vegetation at the second point in time is determined by determining a DGCI for each of the set of images, and determining a health status of the vegetation based on the determined DGCI, wherein the determination of whether to fertilize the vegetation at the second point in time is based at least on whether the determined health status of the vegetation satisfies a predetermined health criterion.

### BRIEF DESCRIPTION OF THE DRAWINGS

FIG. 1 illustrates an exemplary block diagram of the smart irrigation controller which may be employed in accordance to the aspects of the present disclosure.

FIG. 2 illustrates an exemplary flow chart for the processing steps to determine the vegetation health to determine the irrigation in accordance with the aspects of the present disclosure.

FIG. 3 illustrates an exemplary flow chart for the processing steps to determine the irrigation time and the amount of irrigation in accordance with the aspects of the present disclosure.

FIG. 4 illustrates an exemplary flow chart for the processing steps to determine the fertilizer requirement and the control to fertilize the vegetation in accordance with the aspects of the present disclosure.

### DETAILED DESCRIPTION

The foregoing aspects, features and advantages of the present disclosure will be further appreciated when considered with reference to the following description of exemplary embodiments and accompanying drawings, wherein like reference numerals represent like elements. In describing the exemplary embodiments of the present disclosure illustrated in the appended drawings, specific terminology will be used for the sake of clarity. However, the present disclosure is not intended to be limited to the specific terms used.

According to an aspect of the present disclosure, the Smart Irrigation Controller is based on image processing, pattern recognition, and control algorithms to efficiently control the irrigation system and nutrient deficiency detection in plants.

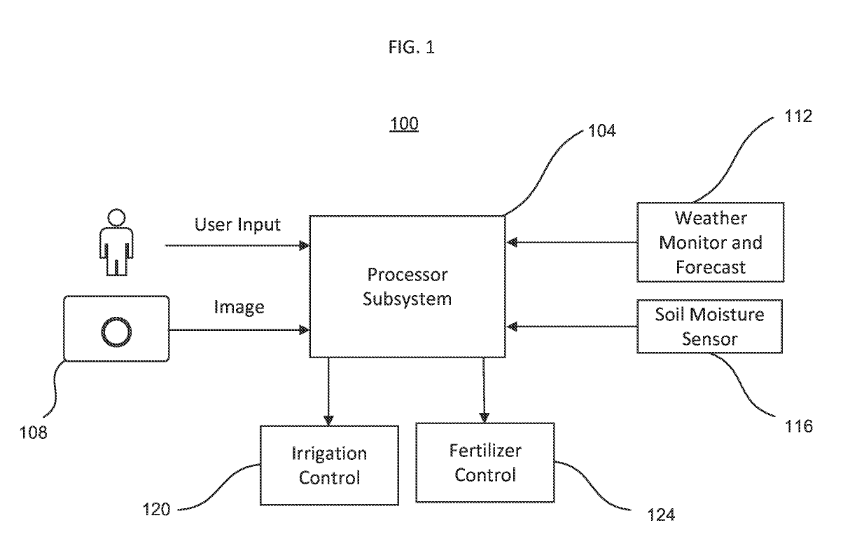

According to an aspect of the present disclosure, as shown in FIG. 1, the Smart Irrigation Controller 100 may comprise a processor subsystem 104, a camera subsystem 108, a weather monitoring and forecast subsystem 112, soil moisture sensor subsystem 116, an irrigation control subsystem 120 and a fertilizer control subsystem 124. The processor subsystem 104 may contain display/user interface to provide information to the user and may receive input from the user. By way of example, the user interface may include one or more actuators, a speaker, a microphone, a full or partial keyboard, a touch screen panel, video or still image display, audio interface, etc. may be employed and managed through the processor subsystem. In another example, the user interface may be a web interface or a mobile app. The processor subsystem 104 in FIG. 1 desirably handles the overall operation of the Smart Irrigation Controller. This may be done by any combination of hardware, software and firmware running on the processing subsystem 104. Such a combination of hardware, software and firmware may embody any methods in accordance with aspects of the present disclosure.

According to the aspects of the present disclosure, the processor subsystem 104 may take inputs from the user, from the camera subsystem 108, from the weather monitor and forecast subsystem 112, and from the soil moisture sensor subsystem 116. According to another aspects of the present disclosure, the processor subsystem can be a dedicated processing unit, or part of any computing and communication device such as a smart phone, cellular phone, tablet, computer, server, etc.

According to another aspect of the present disclosure, the user input may include but is not limited to the following: a user's preferred irrigation plan, such as a conservative plan or a balanced plan or an optimal vegetation health plan. For example, a conservative plan limits irrigation such that the vegetation would survive but not have optimal health, a balanced plan allows for vegetation to have a balance between vegetation health and water conservation. An optimal plan allows for vegetation to have superior health irrespective of the water use. The user may simply override the Smart Irrigation Controller algorithms temporarily or permanently. For example, while testing the system, the user may temporarily override the controller to stop irrigation. Permanent usage is not limited to the following, a user may permanently override a zone or multiple zones in order to deliver the amount of water the user feels best.

According to another aspect of the present disclosure, the user input may also include but is not limited to the following: a user's preferred fertilizer plan, such as a conservative plan or a balanced plan or an optimal vegetation health plan. For example, a conservative plan limits fertilizer such that the vegetation would survive but not have optimal health, a balanced plan allows for healthier vegetation. An optimal plan allows for vegetation to have superior health irrespective of the fertilizer use. The user input may simply override the Smart Irrigation Controller algorithms temporarily or permanently. For example, while testing the system, the user may temporarily override the controller to stop the fertilizer. Permanent usage is not limited to the following, a user may permanently override a zone in order to deliver the amount of fertilizer the user feels best.

According to another aspect of the present disclosure, the processing unit may interface with other subsystems such as the camera subsystem, weather monitor and forecast subsystem, soil moisture subsystem, irrigation control subsystem, fertilizer control subsystem by methods not limited to the following, cables, wireless connections, cellular communications, a web interface, a mobile app, or the combination of multiple means.

According to another aspect of the present disclosure, the processing unit gets images from the camera or by the input from the user, or by both. The camera can be any device with the ability to take images of vegetation that needs to be irrigated and/or fertilized. The images may also include the images from the satellites. According to another aspect of the present disclosure, the user may input images by the means of a serial port, cables, a wireless connection, a web interface, a mobile app, or the combination of multiple means.

According to another aspect of the present disclosure, the processing unit may get input about current weather conditions from weather services such as but not limited to the following, Yahoo Weather, Accuweather, Intellicast, or Weather.com, or from the user, or dedicated instruments sending weather data to the processing unit, through means not limited to the following, serial port, cables, a wireless connection, or a combination of two or more sources.

According to another aspect of the present disclosure, the processing unit may get input about weather forecasts for a preset or configurable amount of time from either weather services such as but not limited to the following, Yahoo Weather, Accuweather, Intellicast, or Weather.com, or from the user, or with dedicated instruments measuring weather data, or a combination of two or more sources which may not be mentioned previously. The processing unit may get input about weather forecast for a preset or configurable amount of time by means of cables, wireless connections, cellular communications, etc.

According to another aspect of the present disclosure, the processing unit may get soil moisture data by means not limited to the following: a soil moisture sensor, a device alike in function to the former, by the input from the user, or by a combination of two or more such inputs. The soil moisture sensor is connected to the processing unit by means not limited to the following, cables, wireless connections, cellular communications, or a combination of two or more means of connection. The soil moisture sensor can be any device with the ability to measure soil moisture in any forms of measurement. The user may input soil moisture data by the means of a serial port, cables, a wireless connection, a web interface, a mobile app, or the combination of multiple means.

According to another aspect of the present disclosure, the smart irrigation controller takes a preset or configurable number of images of the vegetation at a preset or configurable time or time interval, checks the quality of the images with a preset or configurable standard, and executes image processing by any known image processing techniques. For example, the processing unit may take five images starting at 8:00 AM with a time interval of two hours. A known image processing technique with the result of a Dark Green Color Index (DGCI) may be used to process turf grass color, for example. The DGCI is used to calculate the health of vegetation. This method is described in the following academic paper: Douglas E. Karcher, and Michael D. Richardson. “Quantifying Turfgrass Color Using Digital Image Analysis.” Crop Sci. 43:943-951 (2003), the disclosure of which is incorporated herein by reference.

According to another aspect of the present disclosure, a lookup table is formed and trained based on the images obtained by any of the following means described in this disclosure.

According to another aspect of the present disclosure, the images and their image processing results, such as DGCI values, lookup tables, may be stored in the following ways but not limited to the following, such as a hard drive, non-volatile memory, volatile memory, the cloud, a network drive, or stored in the memory of the processing unit. The processing unit may receive images and their image processing results by the means of a serial port, cables, a wireless connection, a web interface, a mobile app, or the combination of multiple means, and store that information in such memory.

According to another aspect of the present disclosure, if it is time for irrigation, the device will check the weather conditions and the weather forecast and the soil moisture level, and will decide to irrigate at the time or at a later time. If irrigation is required, it will determine an optimal time for irrigation based on weather conditions, weather forecasts, and soil moisture levels. For example, if the current weather condition is windy, causing an open irrigation system to lose effectiveness and waste water, the smart irrigation controller shall irrigate at a later time when the irrigation system can be utilized for optimal effectiveness. If the time of irrigation is not optimal, the smart irrigation controller shall check continuously or at a preset or configured interval until it has determined a time in which irrigation will be most effective. The user may control or override this setting by setting a specific time or a time range.

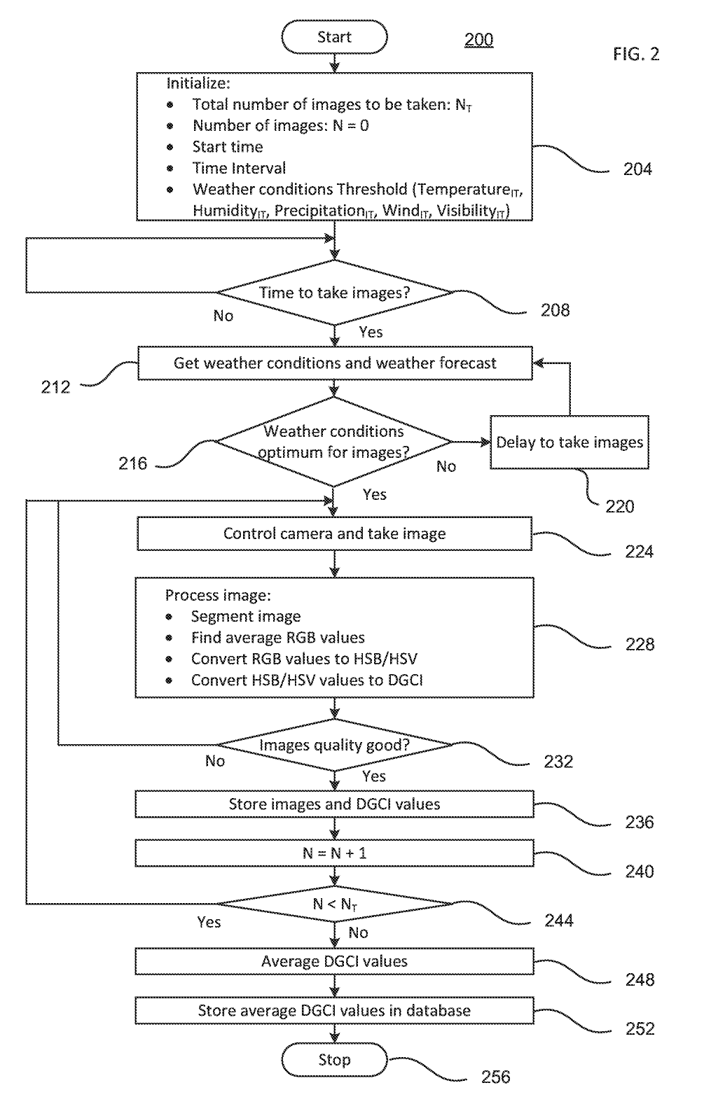

The overall DGCI calculation, an exemplary example of image processing, according to aspects of the present disclosure is illustrated in the exemplary flow diagram 200 of FIG. 2. The processing relevant to the present disclosure begins at processing stage 204 which initializes the configurable parameters. Specifically, the initialization may include the total number of images to be taken per instance, start time to take the images, time interval between the set of images taken, look up table for the image timings according to the day of the year, weather conditions thresholds, etc. The weather conditions threshold may be used to determine the optimum conditions to take the images. For example, the look up table may have recommended timings for each day of the year to take the images. According to an aspect of the present disclosure, the look up table may have weather conditions threshold for each day of the year. According to an aspect of the present disclosure, the lookup table may have recommended timings and the weather conditions threshold for each season of the year. At processing stage 208, a determination is made whether it is the time to take the images based on the look up table and/or the start time to take images. If it is time to take the images, the processing continues to processing stage 212. Otherwise, the processing stays at processing stage 208. At processing stage 212, current weather conditions and the weather forecast are obtained. Next the processing continues to processing stage 216. At processing stage 216, the current weather conditions are obtained and compared against the weather conditions threshold. For example, cloudy weather condition may not be appropriate for good quality images. The weather condition that may be appropriate to take the images may be a clear sky with reasonable sunlight. If the weather conditions are optimum for taking the images, the processing continues to processing stage 224. Otherwise, the processing continues to processing stage 220. At processing stage 220, the smart irrigation controller may delay image capture. The delay to take the images may be a preconfigured period of time, for example 30 minutes, or the delay can be dynamically determined based on the weather forecast. After the delay, the processing returns to processing stage 212. Once the images of the vegetation are taken at the processing stage 224, the processing continues to processing stage 228. At processing stage 228, the images are processed. The processing of the images may include but not limited to segmentation, Red Green and Blue (RGB) value calculation, convert RGB values to Hue, Saturation and Value (HSV) and derive the DGCI according to the equations below. Sometimes Value may be represented as brightness. The Red (R), Green (G) and Blue (B) values are divided by 255 to change the range from 0 to 255 to 0 to 1.

R′=R/255

G′=G/255

B′=B/255

Cₘₐₓ=max(R′,G′,B′)

Cₘᵢₙ=min(R′,G′,B′)

Δ=Cₘₐₓ−Cₘᵢₙ

Hue (H) is calculated as follows:

$$H = \{ \begin{matrix}0 ° , & Δ = 0 \\ 60 ° \times ( \frac{{G}^{′} - {B}^{′}}{Δ} mod 6 ) , & {C}_{max} = {R}^{′} \\ 60 ° \times ( \frac{{B}^{′} - {R}^{′}}{Δ} + 2 ) , & {C}_{max} = {G}^{′} \\ 60 ° \times ( \frac{{R}^{′} - {G}^{′}}{Δ} + 4 ) , & {C}_{max} = {B}^{′}\end{matrix}$$

Saturation (S) is calculated as follows:

$$S = \{ \begin{matrix}0 , & {C}_{max} = 0 \\ \frac{Δ}{{C}_{max}} , & {C}_{max} \neq 0\end{matrix}$$

Value (V) also known as brightness is calculated as follows:

V=Cₘₐₓ

Finally, DGCI is calculated as follows:

$$DGCI = [ \frac{H - 60}{60} + ( 1 - S ) + ( 1 - V ) ] / 3$$

Next the processing continues to processing stage 232. At processing stage 232, a determination is made whether the quality of the images is good, for instance satisfying a predetermined quality threshold, and the DGCI value is reliable. The quality of the images may be determined based on a histogram-based Image Quality Index (HQI). The predetermined quality threshold may be a HQI value. For example, the predetermined quality threshold may be for a given type of vegetation where the predetermined quality threshold is a HQI value that the given type of vegetation is identifiable in a given image. The HQI value for a given type of vegetation may be determined by experimentation. The predetermined quality threshold is then met when the HQI value of the given image meets or exceeds the predetermined quality threshold value.

To determine reliability of the DGCI value, the DGCI value is compared against the expected range of values for that vegetation. The expected range of DGCI values may be determined in the lab or through separate experiments. For example, for turf grass, the expected range of DGCI values is 0-1. In another implementation, the reliability may be determined based on the largest difference between DGCI values for images collected over the period of time. When the largest difference between DGCI values is less than a set value. The period of time may be two days, or more or less, and the set value may be a percentage less than 50% the greatest DGCI value, such as 25% of the greatest DGCI value. If the quality of the images is good and the DGCI value is reliable, the processing continues to next processing stage 236. Otherwise, the processing returns to processing stage 224.

At processing stage 236, the images and the DGCI values are stored. Next the processing continues to processing stage 240. At processing stage 240, the number of set of images and the DGCI value count is incremented. Next the processing continues to processing stage 244. At processing stage 244, a determination is made whether the DGCI value counter reached the threshold value. If the DGCI value counter is less than the configured threshold N_{T}, the processing returns to the processing stage 224. Otherwise, when the threshold N_{T} is met, the processing stage continues to processing stage 248. At processing stage 248, the average of the DGCI values is calculated. Next the processing continues to the processing stage 252. At processing stage 252, the average DGCI value DGCI_{AVE} of the set of images is stored. The determining of the average DGCI suitably terminates the process at stage 256.

According to the aspects of the disclosure, an alternate means of image processing may be performed at the processing stage 228, such as pattern recognition. According to this aspect, the images of similar vegetation are taken at different vegetation health conditions and a pattern is determined. A database of image patterns is created, trained and stored for different vegetation conditions and/or for different vegetation types. The images taken at processing stage 224 can be processed and compared against the stored image pattern to determine current vegetation health conditions. According to another aspect of the disclosure, the database may be adapted with new set of images and trained continuously.

According to an aspect of the present disclosure, a periodic delay may be introduced if, for two or more consecutive images, the image quality is not meeting the predetermined threshold. For example, the delay may be 30 minutes. According to an aspect of the disclosure, the delay may be progressively increased.

According to another aspect of the present disclosure, if the quality of images is not good for a programmed number of images, a notification or warning message is provided to the user to check the camera subsystem. According to an aspect of the present disclosure, a periodic notification or warning message may be provided if there is no acknowledgement from the user. According to aspect of the present disclosure, the notification or warning message may be of any form. For example, text messages, an audio indication, a visual indication, an email notification, etc.

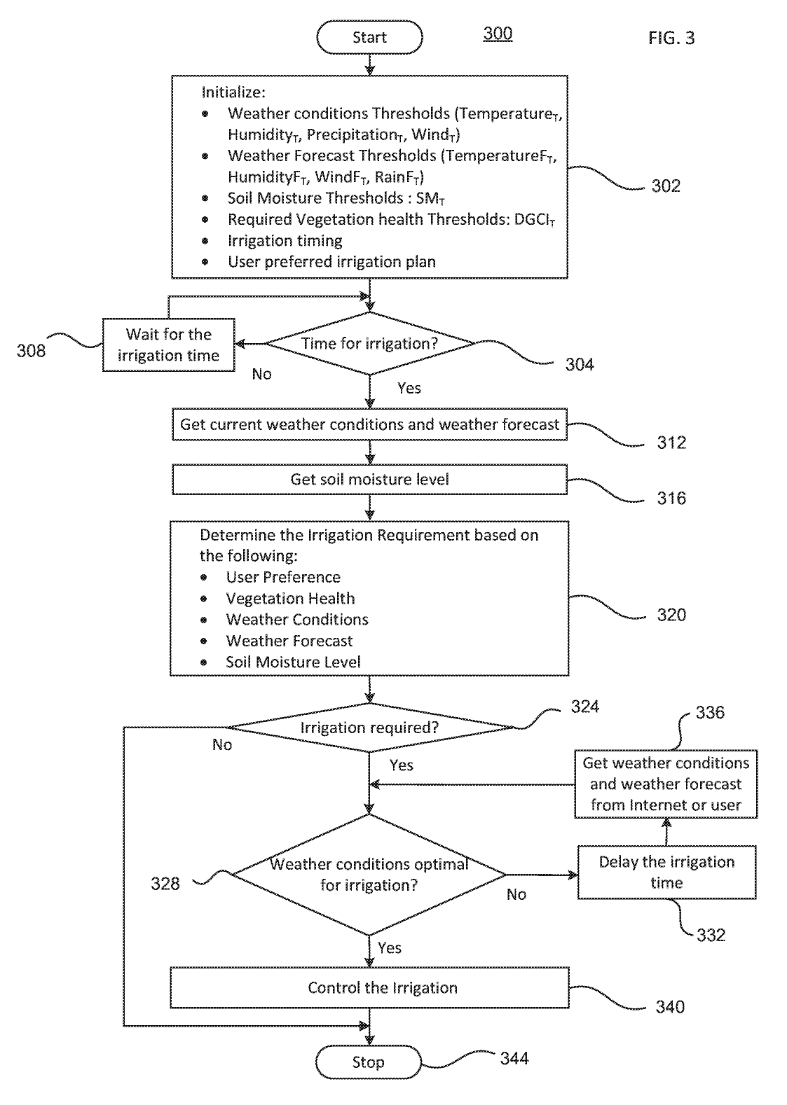

According to aspects of the present disclosure the overall irrigation control is illustrated in the exemplary flow diagram 300 of FIG. 3. The processing relevant to the present disclosure begins at processing stage 302 which initializes the configurable parameters. Specifically, the thresholds for various current weather conditions including but not limited to Temperature_{T}, Humidity_{T}, Precipitation_{T}, Wind_{T}, Visibility_{T}, Rain_{T}, etc.; the thresholds for various weather forecast including but not limited to TemperatureF_{T}, HumidityF_{T}, PrecipitationF_{T}, WindF_{T}, VisibilityF_{T}, RainF_{T}, etc.; soil moisture thresholds SM_{T} for different user preferred irrigation plan; required vegetation health thresholds DGCI_{T} for different user preferred irrigation plan; irrigation timing, user preferred irrigation plan, etc. Next the processing continues to processing stage 304. At processing stage 304, the system checks whether it is time for irrigation. If it is time for irrigation, the processing continues to the processing stage 312. Otherwise, the processing continues to processing stage 308. At processing stage 308, the smart irrigation controller may wait for the time for irrigation in the manner described above. Returning to processing stage 312, current weather conditions and the weather forecast are obtained at processing stage 312. Next the processing continues to the processing stage 316. At processing stage 316, the current soil moisture level is obtained. Next the processing continues to the processing stage 320. At processing stage 320, a determination is made of the irrigation requirement based on some or all of the user preference, vegetation health, current weather conditions, weather forecast, soil moisture level, etc. The irrigation requirement can be dynamically determined based on various parameters including but not limited to the all the above parameters. Based on the various parameters, the amount and the duration of irrigation are determined. According to the aspects of the present disclosure, for example, if the soil moisture is below the threshold level for a chosen irrigation plan, then the irrigation amount is calculated such that after irrigation the moisture level will be at or above the threshold level for the chosen irrigation plan. According to another aspect of the present disclosure, for example, if the weather forecast has predicted rain in the next 24 hours, and the soil moisture level is above the minimum required level, then there is no irrigation required for the next 24 hours unless conditions changed. Next the processing continues to processing stage 324. At processing stage 324, if irrigation is required, the processing continues to processing stage 328. Otherwise, the processing continues to processing stage 344, where the processing of the irrigation control suitably terminates. Returning to processing stage 328, the irrigation controller checks whether the current weather conditions is optimal for irrigation. For example, if the wind is above the preconfigured threshold, then the irrigation may be delayed. If the temperature is above a preconfigured threshold, the irrigation may be delayed. According to aspects of the present disclosure, the irrigation time can be chosen best for the type of vegetation and the time of the day that is optimum. For example, the irrigation time can be chosen 11.00 pm or 2.00 am. If the weather condition is optimum for irrigation, the processing continues to processing stage 340. Otherwise, the processing continues to processing stage 332. At processing stage 332, the smart irrigation controller may delay the irrigation time. The delay for irrigation time may be a preconfigured period of time, for example 30 minutes. According to an aspect of the present disclosure, the delay can be dynamically configured based on the weather forecast information. After the delay of the preconfigured time, the processing continues to processing stage 336. At processing stage 336, current weather conditions and the weather forecast are obtained and the processing continues to processing stage 328. Returning to processing stage 340, the irrigation is controlled for the amount and the duration of irrigation.

According to an aspect of the disclosure, the amount and duration of irrigation can be split into multiple durations and the irrigation time can be dynamically spread for optimum irrigation. For example, if the amount to irrigate is 90% of the normal level and the duration of irrigation is 10 minutes, the irrigation duration can be split two 5 minutes duration at one hour apart. In an another example, if the amount to irrigate is 50% of the normal level and the duration of irrigation is 10 minutes, then there is no split in the irrigation duration. In an yet another example, if the amount to irrigate is 50%, duration of irrigation is 10 minutes, the weather conditions is windy and the soil moisture is below the threshold, then the irrigation duration can be split into two 5 minutes duration and one for at the schedule time and the second one at one hour apart or when the weather condition is favorable whichever is sooner. Likewise the irrigation may be adapted to the various conditions and the user preferences.

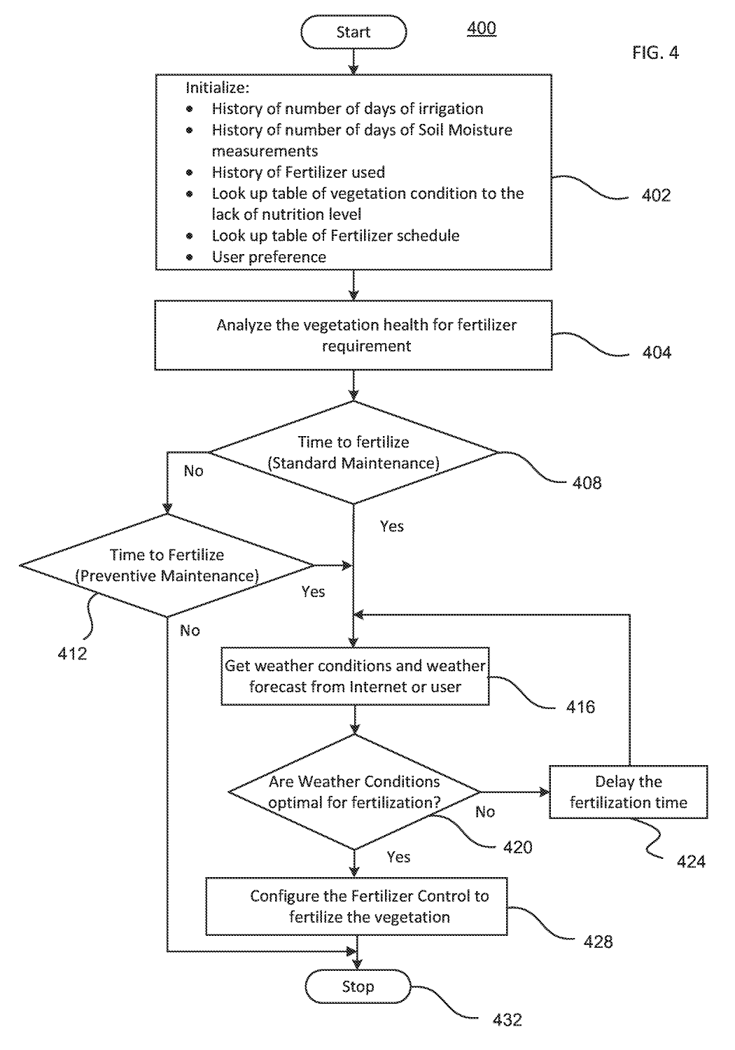

According to aspects of the present disclosure, the optimum fertilizer control of the smart irrigation controller is illustrated in the exemplary flow diagram 400 contained FIG. 4. The processing relevant to the present disclosure begins at processing stage 402 which initializes the configurable parameters. Specifically, the parameters may include the history of the irrigation, such as the irrigation data for the specified number of days, history of soil moisture data such as the soil moisture data for the specified number of days, history of vegetation health index such as vegetation health data for the specified number of days, look up table for the vegetation color change or appearance due to impact of lack of nutrition, look up table for the standard schedule to fertilize the vegetation, user preference on the vegetation health, etc. Next the processing continues to processing stage 404.

At processing stage 404, the vegetation health is analyzed for the fertilizer requirement for the type(s) of vegetation to be fertilized. The set of images taken, processed and stored at processing stages 224, 228, 236 and 252 contained in the flow diagram 200 can be analyzed. The image analysis may include, but is not limited to, pattern of changes over a period of time, the latest pattern and compare the pattern against the look up table that has predefined pattern for lack of specific set of nutrition and determine the amount and type of fertilizer required for the user preference. For example, while processing the images of turf grass, the deficiency of nitrogen may be detected when the symptom shows the turf grass color changed to light green or yellow green from dark green. The change in color may be detected at the tip of a leaf blade, where leaves may start showing signs of death. When this change to light green or yellow green is detected, the type of fertilizer to use may be determined to be a nitrogen-rich type. In another example, while processing the images of turf grass, deficiency of phosphorus may be detected when the symptom shows the turf grass having a reddish-purple at the tip of the leaf blades, dull blue-green color, and/or poor growth. Other factors, such as cold temperature, may also be used in conjunction with the detected characteristics of the turf grass to determine there is a phosphorus deficiency. When the detected characteristics and any other relevant factors indicate a phosphorus deficiency, a type of fertilizer to use may be determined to be a phosphorus-rich type. The type of fertilizer may be either organic or inorganic in accordance with a default setting or a user preference. If the set of images available is not appropriate to analyze the lack of nutrition, according to the aspects of the present disclosure, one or more new sets of images may be taken as per the various processing stages in the exemplary flow diagram 200 contained in FIG. 2. Next the processing continues to processing stage 408.

At processing stage 408, a check is made whether it is time to fertilize as per the standard maintenance schedule. If it is time to fertilize as per the standard maintenance schedule, the processing continues to processing stage 416. Otherwise, the processing continues to processing stage 412. At processing stage 412, check is made to determine whether fertilizer is required based on the determination done at processing stage 404 for preventive maintenance. If fertilizer is required because of preventive maintenance, processing continues to processing stage 416. Otherwise, the processing continues to processing stage 432, where the processing to fertilize the vegetation suitably terminates. Returning to processing stage 416, the irrigation controller checks whether the current weather conditions are optimal to fertilize the vegetation. For example, to fertilize a turf grass, optimum weather condition may include a cool temperature, such as less than 85° F., with rain in the forecast later in the day, such as chance of precipitation over 50%. Alternatively, the optimum weather condition is just a cool day, and the irrigation system is set to water the vegetation immediately after the application of fertilizer. If the weather conditions are optimum, e.g., by falling within predetermined criteria as set forth above, the processing continues to processing stage 428. Otherwise, the processing continues to processing stage 424. At processing stage 424, the smart irrigation controller may delay to fertilize the vegetation when the weather conditions do not satisfy one or more of the predetermined criteria. For example, if the weather forecast is above 85° F., the fertilization is delayed. The delay may be a preconfigured period of time, for example one day. According to an aspect of the present disclosure, the delay can be dynamically configured based on the weather forecast information obtained at processing stage 416. After the delay, the processing continues to processing stage 416. Returning to processing stage 428, the smart irrigation controller configures the fertilizer control subsystem to fertilize the vegetation. Next the processing continues to processing stage 432, where the processing to fertilize the vegetation suitably terminates.

According to the aspects of the present disclosure, the smart irrigation control may not have a fertilizer control mechanism. In such a case, at the processing stage 428, notification may be sent to the user on the amount and type of fertilizer and the time to fertilize. According to an aspect of the present disclosure, a periodic notification may be provided if there is no acknowledgement from the user. According to aspect of the present disclosure, the notification may be of any form. For example, a text messages, an audio indication, a visual indication, an email notification, etc.

According to an aspect of the present disclosure a single controller can control many sectors/zones and stations. For example a single smart irrigation controller can control N number of sectors and M number of stations per sector/zone. N and M may be selected depending on the type(s) of vegetation, irrigation area, amount of fluid to be dispensed, climate, etc. For example, the number of sectors N may be 5 and each sector may have 2 stations. In another example, the number of sectors may be 3 and sector 1 may have two stations, sector 2 may have 3 stations and sector 3 may have one station. In general, each sector may have different number of stations.

According to an aspect of the present disclosure the smart irrigation controller can control different vegetation. Some sectors may have one or more types of vegetation and each type of vegetation may warrant a different set of thresholds and configurations. In such case the smart irrigation controller can control sector or portion of a sector.

According to an aspect of the present disclosure the smart irrigation controller may not have one or more subsystems represented in FIG. 1. For example, the smart irrigation controller may not have Soil Moisture Sensor subsystem. For such cases, the determination and control mechanisms may be adjusted accordingly.

Although the present disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims. Aspects of each embodiment may be employed in the other embodiments described herein.

1. An irrigation control system comprising:
one or more cameras configured to capture images of vegetation; and
at least one processor configured to:
receive a set of images of the vegetation from the one or more cameras;
determine a health status of the vegetation based on the received set of images;
determine whether to irrigate the vegetation at a first point in time based on the determined health status of the vegetation; and
when it is determined to irrigate the vegetation at the first point in time, send instructions to one or more irrigation dispensing elements to irrigate the vegetation.

2. The system of claim 1, wherein:
the at least one processor is further configured to receive user input including at least one of a preferred irrigation plan; and
the determination of whether to irrigate the vegetation at the first point in time is further evaluated on the received user input.

3. The system of claim 1, wherein the at least one processor is configured to determine the health status of the vegetation based on the received images by:
determining a Dark Green Color Index (DGCI) for each of the received set of images, and
determining whether the DGCI satisfies a predetermined baseline criterion for the vegetation.

4. The system of claim 3, wherein the at least one processor is further configured to:
determine a quality value of a given image of the number of images;
compare the determined DGCI to an expected range of DGCI values for the vegetation; and
when the quality value of the given image is below a quality level or the determined DGCI is below the expected range of DGCI values, replace the given image with another image captured by the camera.

5. The system of claim 4, wherein when qualities of two consecutive images are determined to be below the quality level, the at least one processor is configured to provide a notification to check the camera.

6. The system of claim 1, wherein the at least one processor is further configured to determine when to capture, using the camera, each of the images of the vegetation using a look up table, the look up table including recommended timings for when to capture an image for one or both of a given day of the year and a given weather condition.

7. The system of claim 6, wherein the at least one processor is configured to determine when to capture each of the images using the look up table by:
receiving a current weather condition from a weather monitoring and forecast system;
accessing a weather condition threshold stored in the look up table based on a day of the year,
comparing the current weather condition to the weather condition threshold, determining that the current weather condition is appropriate for capturing an image when the current weather condition satisfies the weather condition threshold.

8. The system of claim 1, wherein the at least one processor is further configured to determine an irrigation requirement based on the determined health status of the vegetation, the irrigation requirement including an amount of irrigation and a duration of irrigation.

9. The system of claim 8, wherein the irrigation requirement is further determined according to at least one of a history of irrigation or a history of vegetation health status for the vegetation.

10. The system of claim 1, wherein the at least one processor is further configured to:
receive a weather condition or a weather forecast from a weather monitoring and forecast system;
wherein the determination of whether to irrigate the vegetation at the first point in time is further based on the weather condition or weather forecast.

11. The system of claim 10, wherein the weather condition or the weather forecast includes at least one of wind speed data or temperature data.

12. The system of claim 10, wherein the at least one processor is configured to receive an updated weather condition or an updated weather forecast at a set interval.

13. The system of claim 10, further comprising the weather monitoring and forecast system.

14. The system of claim 1, wherein the at least one processor is further configured to:
determine whether to fertilize the vegetation at a second point in time based on the received data; and
when it is determined to fertilize the vegetation at the second point in time, provide instructions regarding the fertilization of the vegetation to a fertilizer control system based on the received data.

15. The system of claim 14, wherein:
the at least one processor is further configured to receive user input including at least one of a preferred fertilizer plan; and
the at least one processors is configured to determine whether to fertilize the vegetation at the second point in time in accordance with the received user input.

16. The system of claim 14, wherein the at least one processor is configured to determine whether to fertilize the vegetation at the second point in time based on the received data by:
determining a Dark Green Color Index (DGCI) for each of the set of images, and
determining a health status of the vegetation based on the determined DGCI,
wherein the determination of whether to fertilize the vegetation at the second point in time is based at least on whether the determined health status of the vegetation satisfies a predetermined health criterion.

17. The system of claim 14, further comprising the fertilizer control system;
wherein the provided instructions include instructions for operating the fertilizer control system.

18. The system of claim 1, further comprising a soil moisture sensor configured to detect a soil moisture level;
wherein the at least one processor is further configured to:
receive the soil moisture level; and
determine whether to irrigate the vegetation at the first point in time further based on the receive soil moisture level.

19. The system of claim 1, wherein the at least one processor is configured to determine the health status of the vegetation further based on a type of the vegetation.

20. A method comprising:
receiving, by at least one processor, a set of images of vegetation from one or more cameras;
determining, by the at least one processor, a health status of the vegetation based on the received set of images;
determining, by the at least one processor, whether to irrigate the vegetation at a first point in time based on the determined health status of the vegetation; and
when it is determined to irrigate the vegetation at the first point in time, sending, by the at least one processor, instructions to one or more irrigation dispensing elements to irrigate the vegetation.

21. The method of claim 20, wherein the health status of the vegetation is determined by:
determining a Dark Green Color Index (DGCI) for each of the received set of images, and
determining whether the DGCI satisfies a predetermined baseline criterion for the vegetation.

22. The method of claim 21, further comprising:
determining, by the at least one processor, a quality value of a given image of the number of images;
comparing, by the at least one processor, the determined DGCI to an expected range of DGCI values for the vegetation; and
when the quality value of the given image is below a quality level or the determined DGCI is below the expected range of DGCI values, replacing, by the at least one processor, the given image with another image captured by the camera.

23. The method of claim 20, further comprising:
determining, by the at least one processor, whether to fertilize the vegetation at a second point in time based on the received data; and
when it is determined to fertilize the vegetation at the second point in time, providing, by the at least one processor, instructions regarding the fertilization of the vegetation to a fertilizer control system based on the received data.

24. The method of claim 23, further comprising:
receiving, by the at least one processor, user input including at least one of a preferred fertilizer plan; and
determining, by the at least one processor, whether to fertilize the vegetation at the second point in time in accordance with the received user input.

25. The method of claim 23, wherein whether to fertilize the vegetation at the second point in time is determined by:
determining a DGCI for each of the set of images, and
determining a health status of the vegetation based on the determined DGCI,
wherein the determination of whether to fertilize the vegetation at the second point in time is based at least on whether the determined health status of the vegetation satisfies a predetermined health criterion.
